(19) United States
(12) Patent Application Publication
(10) Pub. No.: US 2017/0262874 A1
(43) Pub. Date: Sep. 14, 2017

(54) METHODS AND SYSTEM FOR IDENTIFYING CONSUMER PREFERENCES

(71) Applicant: Mastercard International Incorporated, Purchase, NY (US)

(72) Inventors: AnShul PANDEY, Gurgaon (IN); Mrinal GUPTA, Alwar (IN); Dinesh Kumar LAL, Gurgaon Haryana (IN)

(73) Assignee: Mastercard International Incorporated, Purchase, NY (US)

(21) Appl. No.: 15/449,096

(22) Filed: Mar. 3, 2017

(30) Foreign Application Priority Data
Mar. 10, 2016 (SG) 10201601867T

(51) Int. Cl. G06Q 30/02; G06Q 40/00

(52) U.S. Cl. CPC G06Q 30/0204; G06Q 40/12; G06Q 50/14

(57) ABSTRACT

A method and system are proposed for providing recommendations to providers of products in a travel destination, of which products to offer. For a set of consumers for whom travel data indicates that they will in the future travel to the travel destination, transaction level data is used to obtain product preference data which statistically characterizes products the set of consumers prefer. The product preference data is transmitted to product providers in the travel destination in the form of product recommendations. Thus, by offering products according to the recommendations, the product providers can offer products in the travel destination suited to the set of consumers. A particular application is in the case that the product is food, since using the recommendations restaurants can provide dishes matching the tastes of the visitors to the travel destination.

### FIELD OF THE INVENTION

The present invention relates to methods and systems for identifying patterns in consumer preferences, so that products in accordance with those preferences may be offered to consumers. In particular, the products may be dishes offered by a restaurant.

### BACKGROUND OF THE INVENTION

Visitors to a travel destination, such as holiday makers or business travelers, often roam around the travel destination, and select a restaurant by seeing a display provided by the restaurant of what dishes are available. During certain time periods, the tastes of the visitors may be strongly correlated. In one example, the visitors may come predominantly from a certain geographical region (for example, because the visitors are supporters of a certain sporting team which is based in the geographical region, and which is due to play a match in the travel destination). In this case, the visitors may be pleased to find cuisine from that geographical region on offer in the travel destination. In another case, the travel destination may host a commercial conference, which will attract business travelers who are wealthy enough to pay for dishes including expensive ingredients.

Unfortunately, although restaurant operators become familiar with the dining tastes of people who live near their restaurant, restaurant operators at a travel destination have no reliable way of predicting who will be visiting the travel destination during a certain time period. Even if they are aware that a certain sporting event or commercial conference is being held in the travel destination, they will only be able to guess at the likely food preferences of those attending it. This can lead to expensive errors, if the restaurant owners buy expensive ingredients in excessive quantities, or offer dishes in which the visitors are not interested.

### SUMMARY OF THE INVENTION

The present invention aims to provide methods and systems for making recommendations to suppliers of products in relation to consumers.

In general terms, the invention proposes that, at least for a set of consumers for whom travel data indicates that they will in the future travel to a certain travel destination, transaction level data is used to obtain product preference data which statistically characterizes products the set of consumers prefer (e.g. products those consumers, or similar consumers, have previously purchased from merchants). The product preference data is transmitted to product providers in the travel destination in the form of product recommendations.

By offering products according to the recommendations, the product providers can offer products in the travel destination suited to the set of consumers. Hopefully, the set of consumers will be statistically representative of other visitors to the travel destination during the same time period.

In some embodiments of the invention, the transaction data may be analyzed only for the set of consumers who have already been identified as going to travel to the travel destination. However, alternatively, the transaction data may be analyzed for some or all consumers in a consumer database to generate a product preference model. Later, after the determination of the set of consumers who will travel to the travel destination, the product preference model may be used to generate the product preference data.

The term “product” is used here to include both goods and services. In one embodiment, the products are foods and/or beverages (i.e. the product preference model is a food and/or beverage preference model). The product providers may be business establishments where meals or refreshments may be purchased. Such merchants are here referred to here as “restaurants”. Typically, but not always, the restaurants provide facilities on which the food may be consumed (i.e. they are eat-in restaurants, rather than take-away restaurants). The meals or refreshments are typically pre-cooked (in the case of bakery products, pre-baked), and are typically served warm, although invention is applicable also to restaurants (such as juice bars and certain vegetarian restaurants) where the meals or refreshments are not pre-cooked or served warm. The recommendations provided allow the restaurant operators to offer food recommendations (“chef's specials”) suited to the visitors to the travel destination.

Irrespective of whether the product is food, the recommendations may be transmitted at intervals, e.g. on a weekly basis, and each in relation to a respective time period, and based on visitors who are determined to be going to travel to the travel destination during the period.

The transaction data may be used to obtain product data which identifies the specific product(s) the consumers purchased in the payment transactions.

In a first case, the transaction may be used in combination with additional data relating to the transaction. The additional data may for example be data according to a predefined list of products sold by the merchants. For example, if the merchant operates an inventory system, the additional data may be stock-keeping unit (SKU) data specifying the identity of the purchased products according to the inventory system.

In a second case, optionally combinable with the first, the transaction data may be used in combination with pre-existing price information about the prices of products supplied by the merchant, to infer which products were purchased from the value of the corresponding payment transactions. For example, knowing that the transaction value is the sum of product prices, the embodiment can infer the purchased products if there is a unique combination of products such that the sum of the prices of those products is equal to the transaction value.

Of course, a given consumer may purchase more than one item of a given product within a single payment transaction, and this possibility increases the number of ways in which a certain transaction value can be reached (e.g. a transaction value of $2.58 can be reached as the sum of the prices of two products having respective product prices per item of $1 and $1.58, or the cost of two items of one product having a product price of $1.29 per item). However, probabilistic information, for example from a large number of payment transactions, can be used to show that some possibilities are more likely than others. For example, if a certain consumer's transaction values are always a multiple of $1.29, then it may be inferred that the consumer always purchases a certain number of items with a product price of $1.29.

More generally, a probabilistic algorithm (such as “fuzzy matching”) can be used to obtain the product data in the form of statistical information about the product choices of those items. The statistical information may take into account multiple transactions by a given consumer, and/or transactions by multiple consumers who have been determined to be part of the same consumer market segment.

If the products are food items purchased in restaurant, then the product data may be dish data indicating specific dishes the consumers have previously purchased.

An ingredient database may be used, in combination with the dish data, to obtain ingredient data about food ingredients associated with the purchased dishes. The recommendations may include at least some of the ingredient data.

The travel data may comprise transaction data.

In an embodiment, the transaction data may be data relating to payments made to a business in the travel destination which is typically used by a visitor to the travel destination. For example, the business may be hotel located at the travel destination, or it might alternatively be local car hire company. A database of payment account associated with such businesses may be used to recognize transaction data relating to payments to those businesses, by matching payee payment accounts specified in the transaction data with payment accounts listed in the database.

Alternatively or additionally, the transaction data may further comprise data indicating the payment transaction is to a business in the travel destination. It is known, for example, for transaction data to include “addendum data” specifying what was purchased. This is most common for car rentals, as well as for certain restaurant payments, lodging (hotel) payments and railway payments. It is used for example for verifying expenses claims. Thus, even if the payment transaction is to a merchant which is not associated with a certain travel destination (e.g. a travel booking website), the addendum data may indicate that the consumer will travel to the travel destination. Conveniently, the addendum data may comprise travel dates, indicating the time period(s) during which the consumer will be at the travel destination.

The process of forming a recommendation may comprise calculating a score for each of a number of products, determining products with the highest score and transmitting that score to the product providers.

Optionally, some of all or the consumers in the database may be grouped into clusters, for example based on the corresponding transaction data. For each cluster, a respective score is obtained as a function of the number of consumers in each of the clusters who are determined to be going to travel to the travel destination.

A number of enhancements of the algorithm are possible. For example, the set of consumers may be further selected on the basis of one or more additional criteria. For example, the consumers may be separated into a plurality of classes (market segments), based on the criteria, and then respective product preference data may be generated for one or more of those classes. For example, the criteria may include one of more demographic criteria (e.g. age, gender, ethnicity or marital state), or one or more financial criteria (e.g. income level, total spend per month, or average ticket spend). Each recommendation may then be specific to a consumer market segment. For example, in the case of a product provider which caters for a certain consumer market segment (e.g. high-spending consumers or consumers with a certain demographic), the recommendation given to the product provider may be based on the product preference data of a set of consumers who are determined to be going to travel to the travel destination, and who are in a consumer market segment compatible with the product provider.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers.

The term “travel destination” means any geographical location to which a consumer may travel. It may for example be a geographical region which is a certain town or city; a set of one or more zip code regions; or all locations within a certain distance from a specified geographical point. It may even be a travel destination as specific as a single hotel, since such information may be of interest to providers of products in that hotel, e.g. the operators of restaurants in the hotel. The geographic region may have a size which is in accordance with a typical distance which consumers are prepared to travel to a restaurant. For example, its extent (i.e. which may be defined as the length of the longest straight line which can be drawn entirely within the geographic region) may be at least 50 m, or at least 100 m, and/or at most 10 km, at most 5 km, or at most 2 km.

The term “hotel” is used to mean an enterprise providing overnight accommodation to visitors in a specific geographical location, including guest houses, etc.

Finally, while this document refers to the food preferences of consumers, it is to be understood that these food preferences may in fact be preferences of other individuals for whom the consumers tend to buy food, such as family members of the consumers.

### BRIEF DESCRIPTION OF THE FIGURES

An embodiment of the invention will now be described with reference to the following drawings, in which:

FIG. 1 is a schematic view of a computerized network including a server system which is operative to perform a method which is an embodiment of the invention;

FIG. 2 shows the steps of a method which is an embodiment of the invention;

FIG. 3 shows the sub-steps of a first step of the method of FIG. 2;

FIG. 4 shows transaction data used in the first step of the method of FIG. 2;

FIG. 5 shows product data obtained in the first step of the method of FIG. 2;

FIG. 6 shows the sub-steps of another step of the method of FIG. 2;

FIG. 7 shows travel data used in the other step of the method of FIG. 2;

FIG. 8 shows data generated in the other step of the method of FIG. 2; and

FIG. 9 shows schematically the structure of the server system of FIG. 1.

### DETAILED DESCRIPTION OF THE EMBODIMENTS

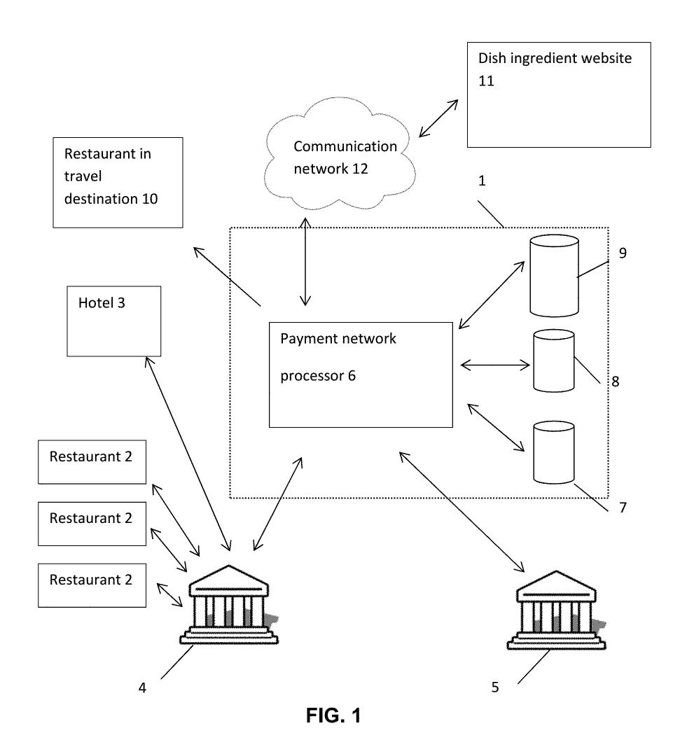

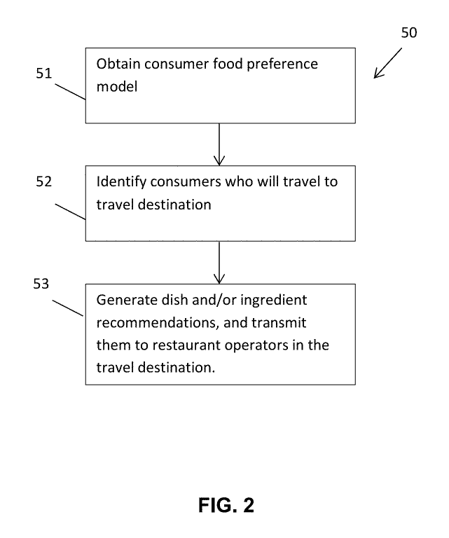

Referring firstly to FIG. 1, a computerized network is shown including a server 1 which can perform a method which is an embodiment of the invention. The method is explained below with reference to FIG. 2. The server 1 is associated with a payment network for processing payment transactions made using payment cards issued by corresponding issuer banks. For that reason the server 1 is referred to here as a “payment network server”. The transactions include payment transactions involving restaurants 2 (for simplicity, just three are illustrated) and at least one hotel 3 (again, for simplicity just one is illustrated). Each of the restaurants 2 may be regarded as a merchant.

The computerized network is capable of performing a known payment process which is as follows. Typically, a consumer who holds a payment card issued by an issuer bank makes a payment by presenting his or her payment card to a terminal operated by one of the merchants 2, 3. The terminal sends a message to a server 4 of an acquirer bank, where the merchant maintains an account, including the details of the payment card (possibly in encrypted form) and the amount of the payment. For simplicity, FIG. 1 assumes that all the restaurants 2 and the hotel 3 use the same acquirer bank 4, but in reality, the merchants will more typically use corresponding ones of a plurality of acquiring banks.

The acquirer bank server 4 sends a message to the payment network server 1, again including the details of the payment card and the amount of the payment. The payment network server 1 determines the issuer bank which issued the payment card, and sends an authorization request to an issuer bank server 5 operated by the issuer bank. For simplicity only a single issuing bank server 5 is illustrated in FIG. 1, although typically there will be many such servers associated with respective issuing banks. The issuer bank server 5 either authorizes the transaction, or declines it, and in any case sends a corresponding message to the payment network server 1, which passes the message to the acquirer bank server 4, which forwards it to the merchants 2, 3. If the decision of the issuer bank server 5 was to authorize the transaction, then the acquirer bank server 4 credits the payment amount (possibly less a handling charge) to the account of the merchant, and the issuer bank server 5 debits it (possibly plus a handling charge) from an account associated with the payment card. At a later time (typically during a clearing operation) the issuer bank makes a payment to the acquirer bank.

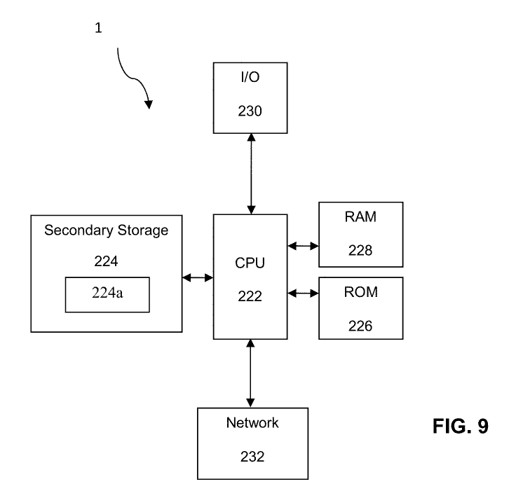

FIG. 1 shows the payment network server 1 as including a processor 6 and a plurality of databases 7, 8, 9. The structure of the payment network server 1 is explained in more detail below with reference to FIG. 9. The payment network server 1 retains details of the payment transaction in a payment database 7.

The payment network server 1 is operative to provide, at intervals, recommendations to a restaurant 10 in a travel destination including at least one hotel 3, of dishes and/or ingredients to offer to visitors to the travel destination. Each recommendation may cover a time window such as a day, a week or a month.

Unlike a conventional payment network server, the payment network server 1 includes a merchant database 8 containing data for each of the merchants 2, 3. It further includes a consumer database 9 containing data for each of a plurality of consumers, all of whom carry one or more corresponding payment cards. Optionally, this data may classify the consumers according to one or more demographic and/or financial characteristics of the consumers. It may further include a home location for each of the consumers.

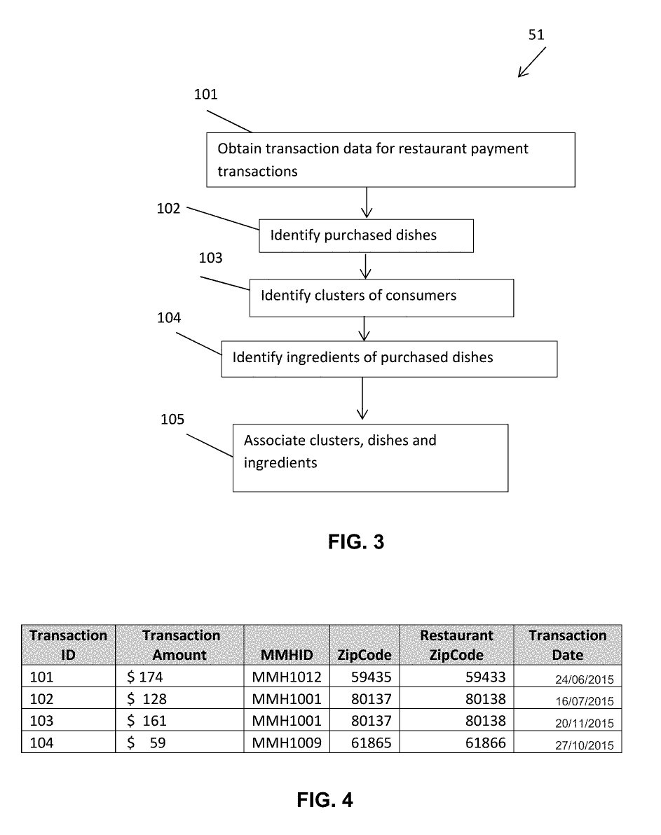

FIG. 2 shows the steps of a method 50 carried out by the payment network server 1. In a first step of the method (step 51) explained below in more detail with reference to FIG. 3, the payment network server 1 uses transaction data stored in the payment database 7 and relating to payment transactions to the restaurants 2, in combination with information about the corresponding restaurants stored in merchant database 8, to form a food preference model indicative of the food preferences of the consumers. The food preference model is stored in the consumer database 9.

Turning to FIG. 3, the sub-steps of step 51 are shown.

In sub-step 101, the restaurants 2 implement the payment process described above, in which they transmit transaction data to the acquirer bank server 4, which passes the data to the payment network server 1 to initiate a payment from the issuer bank 5. As described above the payment network server 1 retains the transaction data in the payment database 7. Using the data in the merchant database 8, it is able to recognize which transactions are in respect of the restaurants 2.

Typical transaction data retained in the payment database 7 in the case of payments to a restaurant is shown in FIG. 4. Each of the rows of the table relates to a corresponding transaction, labeled by a transaction identification number (transaction ID). The transaction data includes the transaction ID, the amount of the transaction, a MMHID (member merchant hierarchy ID; this is a unique location ID which represents the location of a merchant to whom a payment was made; in the present case, that is the MMHID of a restaurant), a zip code associated with the consumer (this may be a zip code of a hotel where the consumer is staying at the time when a transaction is made; as described below this may be obtainable using addendum data, and is not necessarily the same as the zip code of the restaurant), the restaurant zip code, and the transaction date.

In sub-step 102, the payment network server 1 attempts to recognize the individual purchased dishes covered by the payment transaction. Certain ones of the restaurants 2 may provide this “item level” data to the payment network server 1, e.g. in the form of stock-keeping unit (SKU) data. Software for handling SKU data is supplied by the companies such as LUCID of Bangalore India (specifically the product LUCID POS), Hyper Drive Information Technologies of Bangalore India (specifically the product HDPOS), TruePOS of Chennai India, and GoFrugal Technologies Private Ltd of Chennai India.

Furthermore certain payment protocols include SKU data. For example, the MasterPass payment system, operated by MasterCard International Inc., includes item level data in payment transactions. Thus, if the payment network server 1 operates this protocol, or receives data from the server which does, it has access to item level data.

Alternatively, a probabilistic matching algorithm (fuzzy matching) may be used, by matching the transaction amount (specified in the transaction data) with a list of the prices of products (dishes) the restaurant 2 sells. This list of prices may be stored in the database 8. The probabilistic matching algorithm may use information about previous payment transactions the same consumer has made to the same or other restaurants 2. This information may be already stored in the consumer database 9. For example, if it has previously been determined that the consumer has previously bought a certain dish, there is an increased probability that the present payment transaction covers that dish.

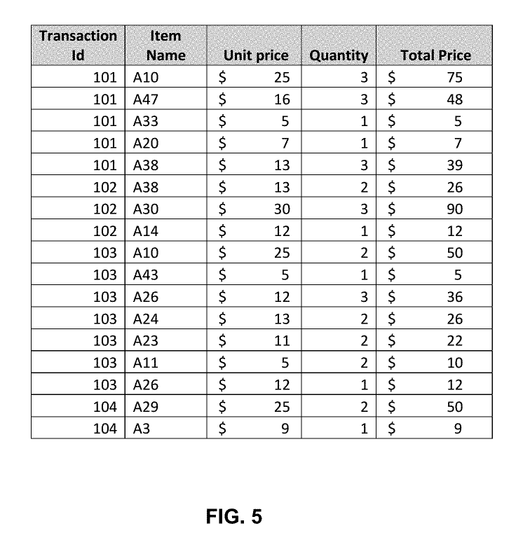

The result of step 2 is shown in FIG. 5. For each of the transactions 101 to 104 shown in FIG. 4, the corresponding purchased dishes have been identified. For example, transaction 101 included 3 units of an item (dish) called A10, 3 units of a dish called A46, one unit of a dish called A33, and one unit of a dish called A20. For each dish, FIG. 5 gives the unit price, the number of units purchased in the transaction, and the total price paid for those units.

In step 103, the server classifies the consumers into clusters based on the products each consumer has purchased, which were identified in step 102. For each of the clusters, the products purchased by the corresponding consumers are used to obtain preference data describing an associated set of product preferences (food preferences). This may, for example, be a list of the dishes which consumers in that cluster most commonly buy.

In step 104, data is obtained which indicates which ingredients are present in each type of dish described by the product preferences. The data may be obtained from an ingredient database may be internal to the payment network server 1, but alternatively, and as shown in FIG. 1, the ingredient database is held by an external dish ingredient server 11 which the payment network server 1 is able to access over a telecommunication network, such as the internet. The external dish ingredient server 11 might be configured as a website which can be accessed using a browser program. Alternatively, it might provide access to the ingredient database through APIs (application program interfaces).

In step 105, the data obtained in step 104 is used to enrich the preference data, so that it now describes not only how the dishes associated with each cluster, but also the ingredients associated with each such dish. Note that the preference data would typically also be indicative of ingredients to which consumers of the cluster have an abhorrence or even an allergy. In fact, the preference data for a particular cluster may include dedicated data indicating that consumers of the cluster have very low compatibility with one or more ingredients.

The preference data for each of the clusters constitutes a food preference model. Step 51 of method 50 is now completed. Note that is not necessary that step 51 is performed using all the consumers in for whom data exists in the consumer database 9 (i.e. the entire “population” of consumers). This is, it may be possible in step 51 to derive a food preference model accurately describing the food preferences of the entire population of consumers using only a sub-set of them. For example, it may be assumed that any consumer in the population has food preferences similar to those of consumers in one of the clusters.

In step 52 of method 50, the payment network server 1 uses transaction data relating to payments certain consumers make to the hotel 3, to identify a set of the consumers who are about to travel to the travel destination where the hotel 3 is located, and for how long. The transaction data may be in the format shown in FIG. 7. Each row of FIG. 7 shows a payment made from a payment account held by a respective one of the consumers. The payment network server 1 receives the transaction data shown in FIG. 7. The transaction data for one of these accounts shows the name of the hotel, a hotel MMH ID, the zip code of the hotel, the check-in data and the check-out date. Some of this data is addendum data, which is conventionally included in payment transactions for hotels, for accounting purposes (e.g. relating to expenses claims). The data may also be used to track past travel data for the consumer.

The payment network server 1 may already store data in the merchant database 8 indicating that the hotel 3 from which the payment transaction was received is associated with one of the travel destinations. If so, the payment server registers that the consumer is about to make a stay at the travel location, for the dates specified by the check-in and check-out date. The payment network server 1 may identify which consumers are going to be present at the travel location during each time window. Note that the check-in and check-out days may indicate that a given consumer will be at the travel location during more than one time window.

Note that in some cases, the consumer will make a hotel booking through a payment portal which relates to multiple hotels (e.g. a travel booking website). In this case, the payment server 1 receives the payment transaction by a payee who is not located at the travel destination (i.e. the payee is not the hotel 3), but the payment network server 1 may still be operative to determine that the payment relates to a hotel at the travel destination, e.g. using the hotel MMH ID or the hotel zip specified in the addendum data. This determination may use information about the hotel 3 stored in the merchant database 7.

Optionally, the payment network server 1 may exclude from the list of consumer identified in step 52 any consumer whose home location (as stored in the consumer database 9) is within a certain distance of the travel destination. These consumers are not truly visitors to the travel destination.

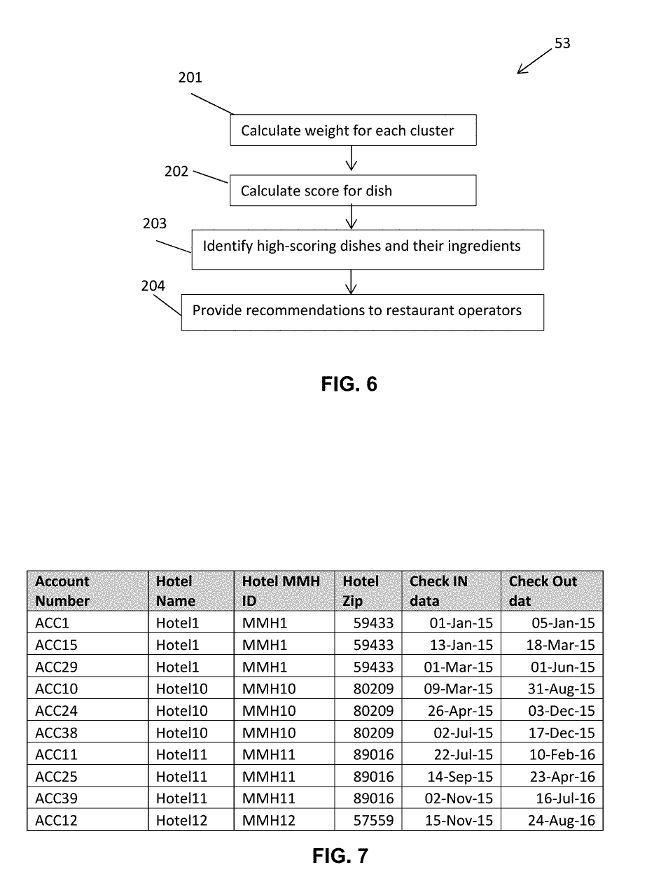

In step 53 of method 50, the payment network server 1 uses the food preference model obtained in step 51, and the set of consumers identified in step 52, to generate recommendation(s) of dishes and/or ingredients to offer consumers, and transmit them to the restaurant operator 10, so that the restaurant operator 10 can use them to produce corresponding “chef's specials”. Step 53 of the method 50 explained below in more detail with reference to FIG. 6. The method of FIG. 6 may be performed in respect of each of time window, to give recommendations in respect of that time window.

In sub-step 201, the payment network server 1 allocates each consumer who was determined in step 52 to be due to travel to the travel destination during the time window, to a respective one of the clusters. This may be done by using data about the consumer stored in the payment database 7 and/or the consumer database 9, to find the cluster for which a set of values defining a center of the cluster is most similar (i.e. the cluster “closest” to the consumer).

As pointed out above, optionally not all consumers in the database 9 may be have been used in step 51, to derive the clusters. Thus, some (or even all) of the consumers identified in step 52 may be ones who were not used in step 51. Nevertheless, provided a sufficiently large number of consumers were used in step 51, and provided the number of clusters derived in step 51 was sufficiently great, it is likely that all of the consumers identified in step 52 will have data similar to the data values defining one of the cluster cores.

In one example, the time window may be a week, and there may be five clusters. In this case, the payment network server 1 may determine in step 52 that 100 of the consumers will visit the travel location during this week: 30 who are closest to cluster 1, 30 who are closest to cluster 2, 40 who are closest to cluster 3, and none who are closest to cluster 4 or 5. In this case, the weights for the five clusters are in the ratio 30:30:40:0:0. Optionally, if the check-in and check-out dates indicate that consumers belonging to one of the clusters will be in the travel destination for a longer/shorter proportion of the time window, the weight of the cluster may be increased/decreased accordingly.

In sub-step 202, the payment network server 1 uses the respective weights for the clusters, and the corresponding preference data for each cluster given by the food preference model, to calculate a “final score” for each of a number of dishes. Specifically, for each dish, the server obtains a score for each cluster, which is a corresponding value indicative of the degree to which consumers of the cluster like the dish. The final score is a sum over the clusters of: the score for each cluster, weighted by the weight of the cluster.

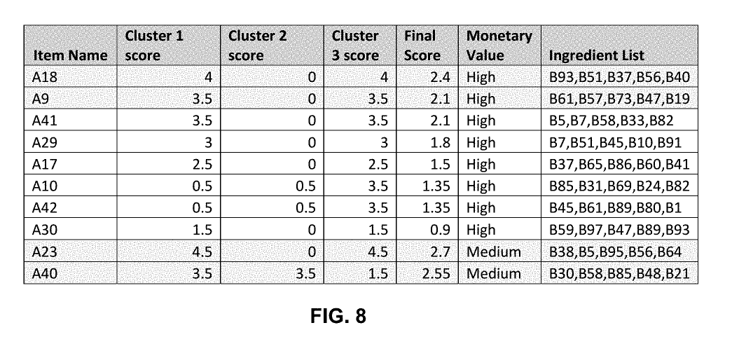

Typical results are shown in FIG. 8. This shows that for dishes (named A18, A9, A41, A29, A17, A10, A42, A30, A23 and A40), each of clusters 1, 2 and 3 (i.e. the three clusters with non-zero weights) has a corresponding score. The sum of the scores gives a final score. The dishes with the highest final score are dishes A9, A18, A23 and A40, and these recommendations are sent to the restaurant 10.

FIG. 8 further shows the monetary value for each dish and the list of ingredients. Both these may be obtained from the website 11 in step 104. Thus, the payment network server 1 is able to recommend to the restaurant operator the ingredients of the highest scoring dishes. In FIG. 8, these are called B93, B51, B37, B56, B40, B61, B57, B73, B47, B19, B30, B58, B85, B48, B21, B38, B5, B95, B56, and B64. Irrespective of whether the restaurant owner decides to make the recommended dish, he or she may be making other dishes using those ingredients.

Although the method has been explained above in relation to providing recommendations to a single restaurant 10 in the same travel destination as the hotel 3, there may be a plurality of restaurants 10 in the same travel destination as the hotel 3, and the payment network server 1 may provide the recommendations to any of these restaurants (e.g. ones which have paid for the recommendations).

Optionally, the recommendations in respect of a given restaurant 10 may be tailored to the restaurant 10. For example, if the restaurant specializes in a certain consumer market segment, the recommendations may be generated only in respect of consumers from that market segment (as identified in the consumer database 9) who are, according to the travel data, going to travel to the destination.

Furthermore, the embodiment may provide the same service to one or more restaurants 10 in each of a plurality of travel destinations, each containing at least one hotel 3.

In an enhancement of the method, information may be transmitted to the consumers (e.g. by the payment network server 1, or the issuing bank of the consumer's payment cards), informing them of which restaurant(s) 10 in the travel destination are receiving the food recommendations. These restaurant(s) may be expected to cater for the consumers' tastes better than other restaurants in the travel destination.

Note that in a variation of the embodiment of FIGS. 1-8, the products may not be foods. That is, the restaurants 2 may be replaced by providers of another product, and the embodiment may be used to generate recommendations for providers of the same type of product in the travel destination. For example, if the restaurants 2 were replaced by car hire companies, the embodiment would be able to recommend to car hire companies which cars to make available in the travel destination.

FIG. 9 is a block diagram showing a technical architecture of the payment network server 1. The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present invention.

1. A computerized system for providing product recommendations to one or more providers of products at a travel destination, the computer system including a computer processor and a data storage device storing program instructions, the program instructions being operative, when implemented by the computer processor, to cause the computer processor:
for at least for a set of consumers for whom travel data indicates that they will in the future travel to the travel destination, to use transaction level data relating to payment transactions made to merchants, to obtain product preference data which statistically characterizes products the set of consumers prefer, and
to transmit the product preference data to the one or more product providers.

2. A computer system according to claim 1 in which the program instructions are operative to cause the processor to generate the product preference data at intervals in relation to respective time periods, the product preference data in respect of each time period being based on a set of consumers who are determined to be going to travel to the travel destination during that time period.

3. A computer system according to claim 1 in which the program instructions are operative to cause the processor to obtain the product preference data by:
(i) analyzing transaction data for a plurality of consumers in a database to generate a product preference model,
(ii) determining the set of consumers who will travel to the travel destination, and
(iii) using the product preference model to generate the product preference data in respect of the determined set of consumers.

4. A computer system according to claim 3 in which the program instructions are operative to cause the processor to:
use the transaction data to group the consumers in the database into a plurality of consumer clusters, the product preference model including, for each of the consumer clusters, a respective set of product preferences;
identify one or more of the consumer clusters to which the set of consumers belong;
generate the product preference data according to the set of product preferences associated with the identified clusters.

5. A computer system according to claim 3 in which the program instructions are operative to cause the processor to use the transaction data, and a database of the prices of products sold by the merchants, to, probabilistically estimate the products purchased in the payment transactions, and generate the product preference model using the estimated products.

6. A computer system according to claim 3 in which the computer server is arranged to receive the transaction data in association with additional data specifying the corresponding purchased products, the product preference model being generated using the additional data.

7. A computer system according to claim 1, which is arranged to transmit the product preference data to restaurants in the travel destination, the products being dishes offered by restaurants.

8. A computer system according to claim 7 which is arranged to access a database of ingredients included in dishes, the product preference data comprising ingredient preference data.

9. A computer system according to claim 1 in which the program instructions are operative to cause the processor to generate the travel data by recognizing transaction data for payments relating to enterprises providing goods or services at the travel destination.

10. A computer system according to claim 1 in which the program instructions are operative to calculate a respective score for each of a number of products, and determine one or more of the products with the highest respective score.

11. A computer system according to claim 1 in which the program instructions are operative to cause the processor to generate the product preference data using duration data characterizing the time that the set of consumers will spend in the travel destination.

12. A computer-implemented method for providing product recommendations to one or more providers of products at a travel destination, the method comprising a computer server performing the steps of:
for at least for a set of consumers for whom travel data indicates that they will in the future travel to the travel destination, using transaction level data relating to payment transactions made to merchants, to obtain product preference data which statistically characterizes products the set of consumers prefer, and
to transmit the product preference data to the one or more product providers.

13. A computer-implemented method according to claim 12 which comprises generating the product preference data at intervals in relation to respective time periods, the product preference data in respect of each time period being based on a set of consumers who are determined to be going to travel to the travel destination during that time period.

14. A computer-implemented method according to claim 12 in which the step of obtaining the product preference data comprises:
(i) analyzing transaction data for a plurality of consumers in a database to generate a product preference model,
(ii) determining the set of consumers who will travel to the travel destination, and
(iii) using the product preference model to generate the product preference data in respect of the determined set of consumers.

15. A computer-implemented method according to claim 14 in which:
the step of generating the product preference model includes using the transaction data to form a plurality of consumer clusters, each consumer cluster being associated with a respective set of product preferences; and
the step of using the product preference model comprises identifying one or more of the consumer clusters to which the set of consumers belong, and generating the product preference data according to the set of product preferences associated with the identified clusters.

16. A computer-implemented method according to claim 14 in which the step of generating the product preference model includes using the transaction data, and a database of the prices of products sold by the merchants to, probabilistically estimate the products purchased in the payment transactions.

17. A computer-implemented method according to claim 14 further comprising the computer server receiving the transaction data in association with additional data specifying the corresponding purchased products, the step of generating the product preference model using the additional data.

18. A computer-implemented method according to claim 12 in which the product are food products, and the product providers are restaurants.

19. A computer-implemented method according to claim 18 further comprising accessing a database of ingredients included in dishes, the product preference data comprising ingredient preference data.

20. A computer-implemented method according to claim 12 further including generating the travel data by recognizing transaction data of payments relating to enterprises providing goods or services at the travel destination.

21. A computer-implemented method according to claim 20 in which the enterprises are hotels located at the travel destination.

22. A computer-implemented method according to claim 20 in which the enterprises are recognized using addendum data included in the transaction data.

23. A computer-implemented method according to claim 12 in which the step of generating the product preference data includes calculating a respective score for each of a number of products, and determining one or more of the products with the highest respective score.

24. A computer-implemented method according to claim 1 in which the step of generating the product preference data uses duration data characterizing the time that the set of consumers will spend in the travel destination.
